(19) United States
(12) Patent Application Publication
(10) Pub. No.: US 2025/0189694 A1
(43) Pub. Date: Jun. 12, 2025

(54) Modeling a Subsurface Formation Using an Unstructured Grid

(71) Applicant: Saudi Arabian Oil Company, Dhahran (SA)

(72) Inventor: Ivan Nikulshin, Dhahran (SA)

(21) Appl. No.: 18/533,698

(22) Filed: Dec. 8, 2023

(51) Int. Cl. G01V 20/00; E21B 43/00; E21B 49/00

(52) U.S. Cl. CPC G01V 20/00; E21B 43/00; E21B 49/00; E21B 2200/20

(57) ABSTRACT

Systems and methods for modeling a subsurface formation include obtaining geological data and petrophysical data from the subsurface formation; forming an unstructured grid representing the subsurface formation by determining locations for nodes of the unstructured grid and connecting the nodes to other nodes in the unstructured grid using connectors. The lengths of the connectors are based on distances between the nodes and boundaries of the unstructured grid. Geological and petrophysical properties are assigned to the nodes based on the geological data and petrophysical data; permeability values are assigned to the connectors based on the petrophysical data. A volume of fluids in the subsurface formation is estimated based on the lengths of the connectors of the unstructured grid and based on the geological and petrophysical properties assigned to the nodes and the permeability values assigned to the connectors.

### TECHNICAL FIELD

This disclosure generally relates to modeling a subsurface formation.

### BACKGROUND

Geological and geodynamical models of subsurface formations are used in the oil and gas industry, for example, to determine locations of hydrocarbon initial in place and to assess reserves. Models that more accurately represent the subsurface formation can produce more realistic estimates of the hydrocarbons within the subsurface formation as compared with models with less accuracy.

### SUMMARY

This disclosure describes systems and methods for modeling a subsurface formation. A data processing system (e.g., a computer or control system) obtains geological data and petrophysical data from the subsurface formation. The data processing system forms an unstructured grid representing the subsurface formation by determining locations for nodes of the unstructured grid and connecting the nodes to other nodes of the unstructured grid using connectors. Lengths of the connectors are based on distances between the nodes and boundaries of the unstructured grid. Nodes in the unstructured grid are connected by the connectors. The data processing system assigns geological and petrophysical properties to the nodes based on the geological data and the petrophysical data. The data processing system assigns permeability values to the connectors based on the petrophysical data. The data processing system determines a volume of fluids in the subsurface formation based on the lengths of the connectors of the unstructured grid and based on the geological and petrophysical properties assigned to the nodes and the permeability values assigned to the connectors.

Implementations of the systems and methods of this disclosure can provide various technical benefits. The unstructured grid with nodes and connectors can more realistically model flow in the subsurface formation as compared with a grid with cubical cells. For example, fluid can flow directly to a node through a connector versus flowing through a zigzag path in a rectangular or cubical grid. Dynamic simulations using an unstructured grid with nodes and connectors can be faster than dynamic simulation using cubical cells because the unstructured grid can be free from issues such as twisted cells and negative volume cells that can slow down dynamic simulations with grids with cubical cells. A data processing system can build a geological model based on an unstructured grid with nodes and connectors faster than a grid with cubical cells because the unstructured grid does not need to be upscaled, avoiding extra processing steps. An unstructured grid with nodes and connectors can more accurately preserve geological shapes for facies modelling, relative to a grid having cubical cells. A model built with an unstructured grid with nodes and connectors can accurately estimate fluid volumes for subsurface formations with tilted fluid contacts because the nodes and connectors can conform to the shape of the tilted fluid contact.

The details of one or more implementations of these systems and methods are set forth in the accompanying drawings and the description below. Other features, objects, and advantages of these systems and methods will be apparent from the description and drawings, and from the claims.

### DESCRIPTION OF DRAWINGS

FIG. 1 is a schematic view of a seismic survey and well log operation being performed to measure properties of a subsurface formation.

FIG. 2 is a flow chart of a method for modeling a subsurface formation.

FIG. 3 shows an example three-dimensional unstructured grid.

FIG. 4 shows a node and connectors for an unstructured grid.

FIGS. 5-6 are schematic comparisons between rectangular grids and unstructured grids.

FIG. 7 shows an unstructured grid with higher node density in a highly karstified region of the grid than other regions.

FIG. 8 shows an unstructured grid for a homogeneous geological formation.

FIG. 9 is a schematic of hard and soft boundaries in an unstructured grid.

FIG. 10 is a schematic representation of an unstructured grid conforming to a tilted fluid contact.

FIG. 11 is a schematic representation of facies modeling using an unstructured grid.

FIG. 12 illustrates hydrocarbon production operations that include field operations and computational operations, according to some implementations.

FIG. 13 is a block diagram illustrating an example computer system used to provide computational functionalities associated with described algorithms, methods, functions, processes, flows, and procedures according to some implementations of the present disclosure.

Like reference symbols in the various drawings indicate like elements.

### DETAILED DESCRIPTION

This specification describes systems and methods for modeling a subsurface formation, for example, geological or petrophysical modeling. Estimations of hydrocarbon reserves based on subsurface models are useful for producing hydrocarbons from the subsurface. A data processing system (e.g., a computer or control system) obtains geological data and petrophysical data from the subsurface formation. The data processing system forms an unstructured grid representing the subsurface formation by determining locations for nodes of the unstructured grid and connecting the nodes to other nodes of the unstructured grid using connectors. Lengths of the connectors are based on distances between the nodes and boundaries of the unstructured grid. nodes in the unstructured grid by the connectors. The data processing system assigns geological and petrophysical properties to the nodes based on the geological data and the petrophysical data. The data processing system assigns permeability values to the connectors based on the petrophysical data. The data processing system determines a volume of fluids in the subsurface formation based on the lengths of the connectors of the unstructured grid and based on the geological and petrophysical properties assigned to the nodes and the permeability values assigned to the connectors.

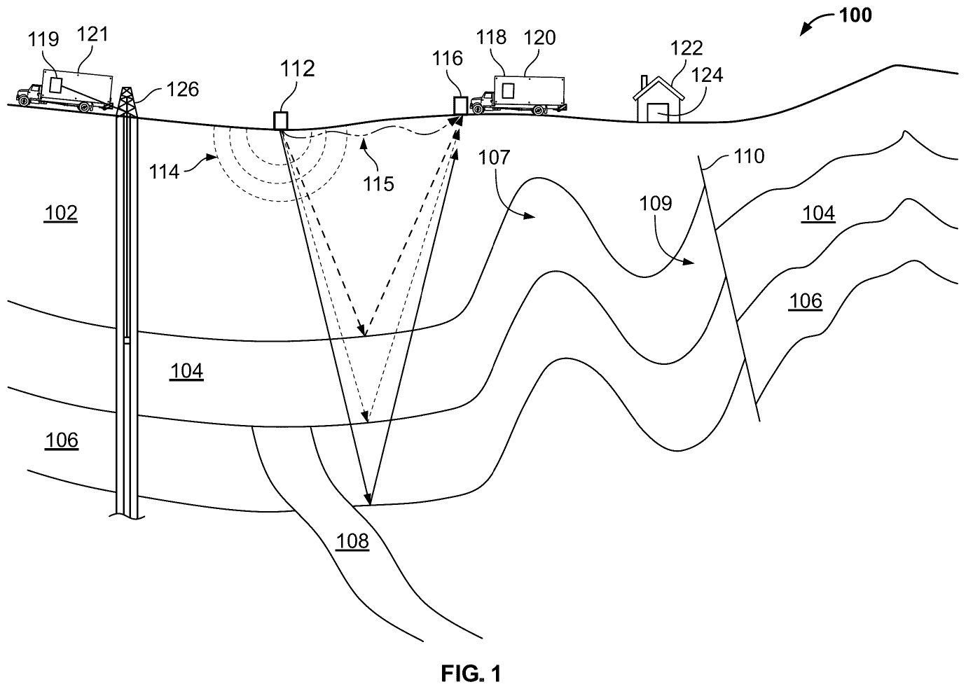

FIG. 1 and well log operation being performed to measure properties of a subsurface formation 100. The subsurface formation 100 includes a layer of impermeable cap rocks 102 at the surface. Facies underlying the impermeable cap rocks 102 include a sandstone layer 104, a limestone layer 106, and a sand layer 108. A fault line 110 extends across the sandstone layer 104 and the limestone layer 106.

A seismic source 112 (for example, a seismic vibrator or an explosion) generates seismic waves 114 that propagate in the earth. The velocity of these seismic waves depends on properties such as, for example, density, porosity, and fluid content of the medium through which the seismic waves are traveling. Different geologic bodies or layers in the earth are distinguishable because the layers have different properties and, thus, different characteristic seismic velocities. For example, in the subsurface formation 100, the velocity of seismic waves traveling through the subsurface formation 100 will be different in the sandstone layer 104, the limestone layer 106, and the sand layer 108. As the seismic waves 114 contact interfaces between geologic bodies or layers that have different velocities, the interface reflects some of the energy of the seismic wave and refracts part of the energy of the seismic wave. Such interfaces are sometimes referred to as horizons.

The seismic waves 114 are received by a sensor or sensors 116. Although illustrated as a single component in FIG. 1, the sensor or sensors 116 are typically a line or an array of sensors 116 that generate an output signal in response to received seismic waves including waves reflected by the horizons in the subsurface formation 100. The sensors 116 can be geophone-receivers that produce electrical output signals transmitted as input data, for example, to a computer 118 on a seismic control truck 120. Based on the input data, the computer 118 may generate a seismic data output such as, for example, a seismic two-way response time plot.

A control center 122 can be operatively coupled to the seismic control truck 120 and other data acquisition and wellsite systems. The control center 122 may have computer facilities for receiving, storing, processing, and/or analyzing data from the seismic control truck 120 and other data acquisition and wellsite systems. For example, computer systems 124 in the control center 122 can be configured to analyze, model, control, optimize, or perform management tasks of field operations associated with development and production of resources such as oil and gas from the subsurface formation 100. Alternatively, the computer systems 124 can be located in a different location than the control center 122. Some computer systems are provided with functionality for manipulating and analyzing the data, such as performing seismic interpretation or borehole resistivity image log interpretation to identify geological surfaces in the subsurface formation or performing simulation, planning, and optimization of production operations of the wellsite systems.

Oil and gas tend to rise through permeable reservoir rock until further upward migration is blocked, for example, by the layer of impermeable cap rock 102. Seismic surveys attempt to identify locations where interaction between layers of the subsurface formation 100 are likely to trap oil and gas by limiting this upward migration. For example, FIG. 1 shows an anticline trap 107, where the layer of impermeable cap rock 102 has an upward convex configuration, and a fault trap 109, where the fault line 110 might allow oil and gas to flow in with clay material between the walls trapping the petroleum. Other traps include salt domes and stratigraphic traps.

One or more test wells 126 can be drilled into the subsurface formation to measure the properties of the source rock within the formation. A control center 122 can be operatively coupled to a well logging unit 121 and other data acquisition and wellsite systems. The control center 122 may have computer facilities for receiving, storing, processing, and analyzing data from the well logging unit 121 and other data acquisition and wellsite systems that provide additional information about the subsurface formation. For example, the control center 122 can receive data from a computer 119 associated with a well logging unit 121.

Well data (e.g., well logging data and core data) is associated with specific locations in the subsurface formation. Various constraints can result in these locations being clustered with some wells close to each other and others spaced farther apart.

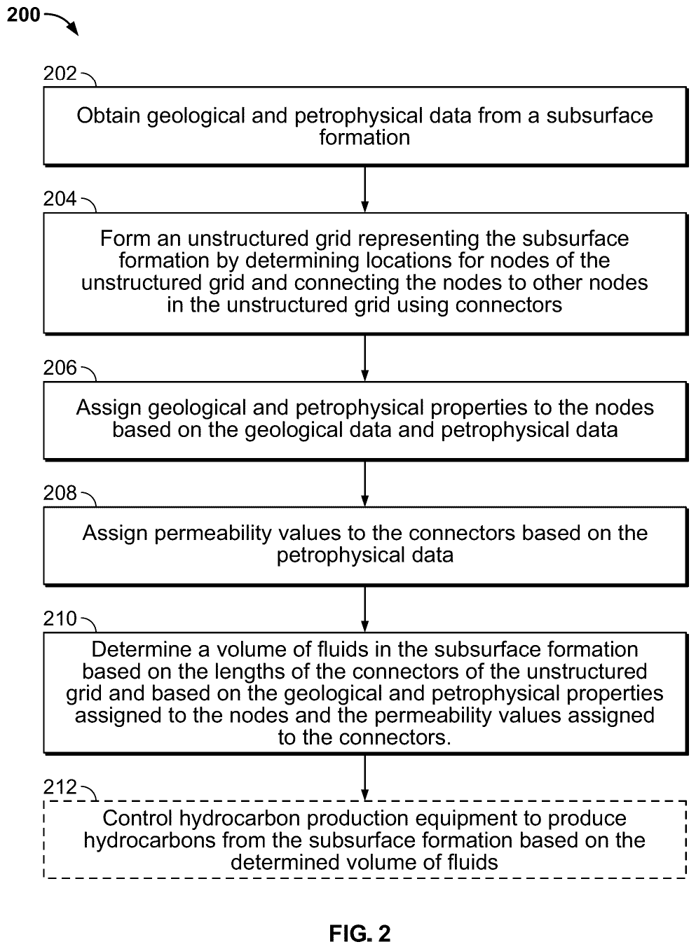

FIG. 2 is a flow chart for an example method 200 for modeling a subsurface formation. The method 200 can be implemented on a data processing system such as a computer or control system (e.g., computer 118). The method 200 can be used to estimate volumes of hydrocarbons in a subsurface formation and to estimate field reserves.

The data processing system obtains (202) geological data and petrophysical data from the subsurface formation. For example, the data processing system obtains well log data, core samples, and/or seismic data from a survey operation (e.g., the operation of FIG. 1). The geological data can indicate, for example, stratigraphic layers, faults, facies, or other geological data. Petrophysical data can include porosity, permeability, net to gross ratio, and hydrocarbon saturation. In some implementations, the data processing system accesses the geological data and the petrophysical data from a data store.

The data processing system forms (204) an unstructured grid representing the subsurface formation. The unstructured grid includes nodes and connectors. The data processing system determines locations of the nodes. The nodes of the unstructured grid are connected to other nodes of the grid by the connectors. The lengths of the connectors are based on the distance between nodes and the boundaries of the unstructured grid. Each node can be connected to, for example, 12 connectors. Fewer connectors (e.g., 4 connectors, 6 connectors, 8 connectors, 10 connectors) or more connectors (e.g., 14 connectors, 16 connectors) can be connected to each node. The unstructured grid can be a three-dimensional grid. Connectors can also connect nodes to boundaries of the grid.

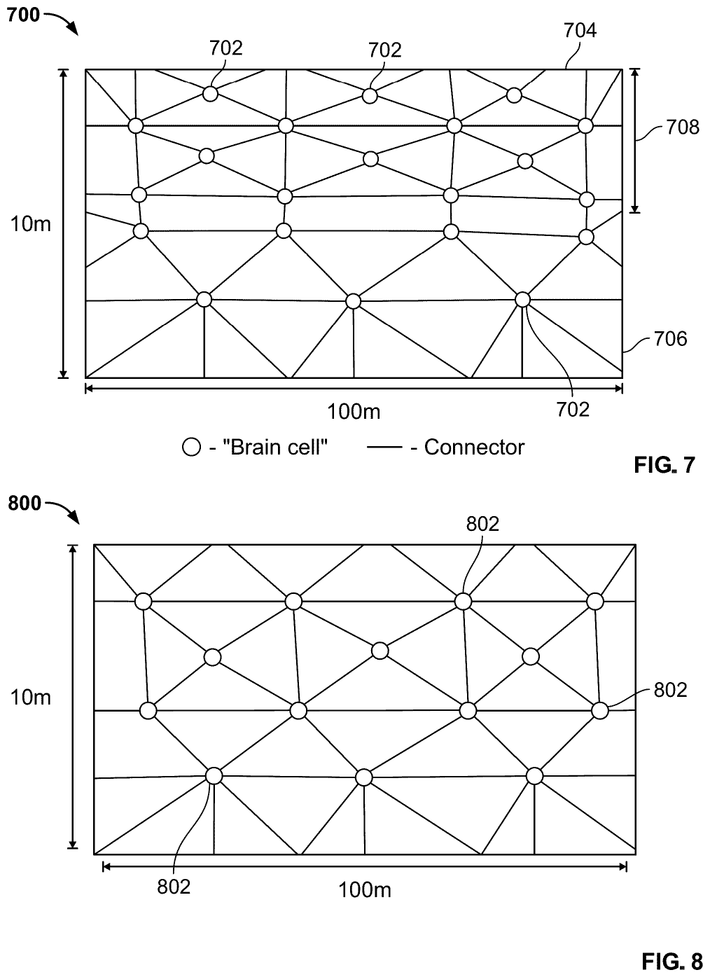

In some implementations, the data processing system determines a density of nodes in the unstructured grid based on stratigraphic layering or other features of the subsurface formation. For example, the density of nodes in the unstructured grid can be higher for regions of the unstructured grid representing faults and/or horizontal wells in the subsurface formation than for other regions in the unstructured grid. A higher density of nodes in a region corresponds to more nodes in that region than in other regions of the same size or volume. Node density is subsequently discussed in more detail in reference to FIGS. 7, 8, and 11.

The data processing system assigns (206) geological and petrophysical properties to the nodes based on the geological data and petrophysical data. For example, the data processing system assigns geological and petrophysical properties to the nodes based on the corresponding location in the subsurface formation. Nodes near wellbore locations can be assigned property values derived from well logs and/or core samples. In some implementations, the data processing system disperses geological and petrophysical properties within the unstructured grid from nodes corresponding to locations where geological or petrophysical data was collected (e.g., well locations, seismic survey locations) to nodes corresponding to locations where no measurements were collected using, for example, stochastic simulations (e.g., Stochastic Gaussian Simulation), kriging, or spatial interpolation.

The data processing system assigns (208) permeability values to the connectors based on the petrophysical data. For example, the data processing system can assign permeability values to the connectors based on core sample permeability measurements or permeability derived from well logs. In some implementations, the data processing system can assign permeability values to the connectors based on the direction of the connectors. For example, the data processing system can assign permeability values based on horizontal and vertical permeability ratios based on the petrophysical data. Assigning permeability values to the connectors based on the direction of the connectors enables anisotropic fluid flow around each node in the unstructured grid.

The data processing system determines (210) a volume of fluids in the subsurface formation based on the lengths of the connectors of the unstructured grid and based on the geological and petrophysical properties assigned to the nodes and the permeability values assigned to the connectors. For example, the data processing system can determine a volume around each node based on the length of the connectors attached to each node and sum the volumes associated with each node in the unstructured grid. The sum of the volumes above free water level corresponds with the volume of hydrocarbons in the subsurface formation (e.g., the field).

Determining the volume of fluid in a subsurface formation using an unstructured grid can produce volume estimations with higher accuracy than rectangular or cubical grids. In particular, for subsurface formations with tilted fluid contacts or irregular boundaries, the unstructured grid can conform to the boundaries using varied connector lengths connected to the boundaries whereas a rectangular or cubical grid may have cells only partially filled with fluid at such boundaries. Volume estimation for partially filled cells is less accurate than volume estimation for full cells in rectangular or cubical grids.

An unstructured grid with nodes and connectors can be used in a variety of geological modeling and dynamic simulation processes (e.g., reservoir simulations). The formation of the unstructured grid takes into account the complexities of the subsurface formation. Consequently, the unstructured grid does not need to be upscaled for reservoir or geological simulation processes. In some implementations, additional properties can be assigned to the nodes such as pressure-volume-temperature properties including fluid expansion factor, gas-oil ratio (GOR) and so forth that vary with the depth of the formation.

In some implementations, the data processing system performs dynamic hydrocarbon production simulations to assess oil/gas field reserves. For example, the data processing system can estimate field reserves in the subsurface formation based on the simulated hydrocarbon production. The data processing system can optimize hydrocarbon production from the subsurface formation based on the estimated field reserves, (e.g., determining locations to produce hydrocarbons having higher hydrocarbon density relative to other locations).

The data processing system can control (212) hydrocarbon production equipment to produce hydrocarbons from the subsurface formation based on the determined volume of fluids. For example, the data processing system can generate control commands to control hydrocarbon production equipment to produce more or fewer hydrocarbons from the subsurface formation based on the determined volume of fluid. Specifically, the data processing system can generate control commands to drill or otherwise target regions in the subsurface formation that show a greater volume of fluid relative to other areas of the subsurface. In some implementations, the data processing system generates control commands based on estimated hydrocarbon field reserves in the subsurface formation.

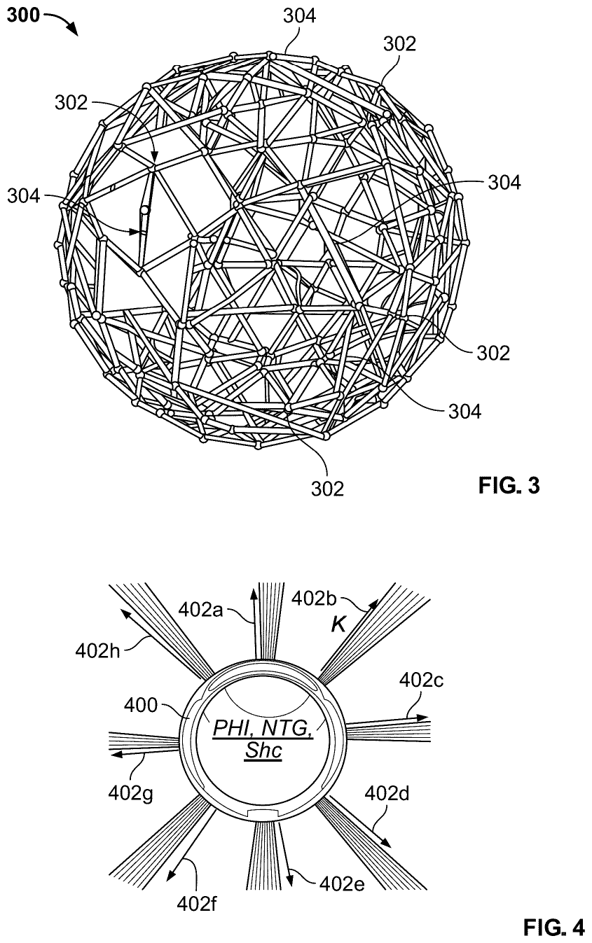

FIG. 3 shows a schematic of an example three dimensional unstructured grid 300 with nodes 302 and connectors 304. In this example, the unstructured grid 300 is shown as forming a spheroid; however, other three-dimensional shapes are possible. For example, the unstructured grid can conform to the geometry of boundaries in the subsurface formation such as faults, stratigraphic layers, tilted fluid contacts, and so forth.

FIG. 4 is a schematic of a single node 400 shown with 8 out of 12 connectors 402a-h (the remaining 4 connectors are not shown in the two dimensional schematic). Petrophysical properties have been assigned to the node 400 including porosity (PHI), net to gross ratio (NTG), and hydrocarbon saturation (Shc). Permeability (K) values have been assigned to the connectors 402. The permeability values for each connector can be different based on the direction of the connector and specific horizontal and vertical permeability ratios. For example, a vertical connector 402a can have a vertical permeability value, a horizontal connector 402g can have a horizontal permeability value, and a diagonal connector 402d can have a permeability value based on the angle or direction of the connector 402d with respect to a horizontal or vertical reference and an associated ratio of horizontal and vertical permeability values.

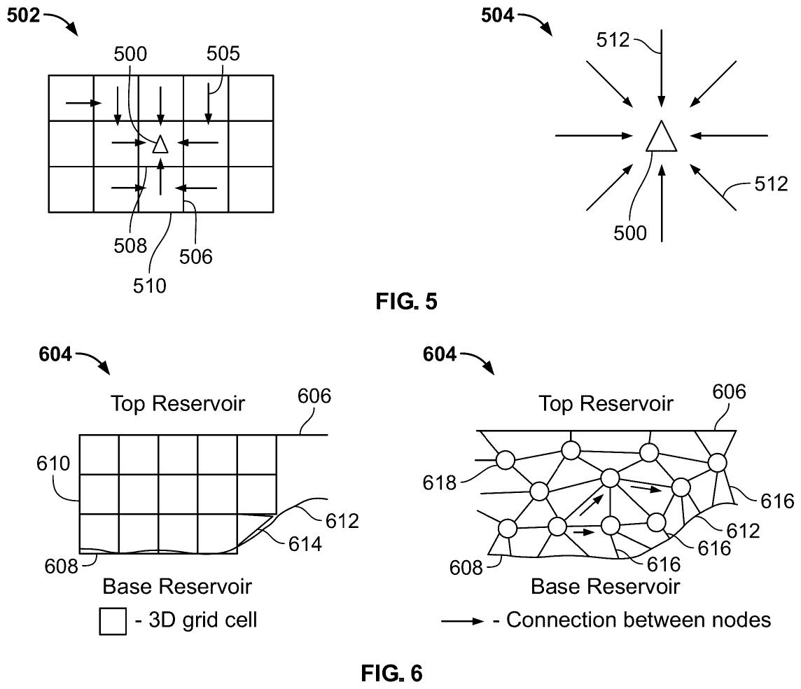

FIG. 5 shows a schematic comparison of fluid flow to a well 500 in two dimensional rectangular grid 502 versus fluid flow to the well 500 in a physically representative scenario 504. In the rectangular grid 502, the fluid streamline 505 are constrained to flow through the horizontal 506 or vertical faces 508 of cells 510. For the fluid to reach the well 500, the fluid zigzags through the horizontal 506 and vertical faces 508. In the physically representative scenario 504, the fluid streamlines 512 can flow directly to the well 500 in a straight line. Using an unstructured grid with nodes and connectors can enable fluid flow within the grid to flow directly to a well by controlling the node density and connector orientations.

FIG. 6 shows a schematic comparison between a rectangular grid 600 and an unstructured grid 602 fitted to a reservoir 604. The top 606 of the reservoir 604 is a straight line; however, the base 608 of the reservoir has an irregular geometry. The rectangular grid 600 can fit the top 606 of the reservoir 604 well since the top 606 is straight and the edges of the cells 610 of the rectangular grid 600 are straight. At the base 608 of the reservoir 604, the rectangular grid approximates the base 608 as a straight line. When the base has a vertical incline 612, the rectangular grid 600 includes a triangular cell 614, which is a partial rectangular cell 610. On the other hand, the unstructured grid 602 can accommodate both the straight top 606 and the irregular base 608 by adjusting the length of the connectors 616 connected to the nodes 618 and each of the boundaries.

FIGS. 7-8 show schematic examples of node density variation in an unstructured grid. In FIG. 7, the data processing system follows the stratigraphic layering of the subsurface formation to determine placement of nodes 702 in the unstructured grid 700. In the top region 704 of the unstructured grid 700, the nodes 702 are closer together reflecting a higher node density than in the bottom region 706 of the unstructured grid 700. The higher node density in the top region corresponds with a highly karstified zone 708 (e.g., a zone with ridges and other landforms resulting from dissolution of soluble rocks) in the subsurface formation. In FIG. 8, the unstructured grid 800 has a uniform node density (e.g., nodes 802 are distributed evenly throughout the unstructured grid 800) to correspond with a homogeneous sandstone formation in the subsurface formation.

In general, the density of the nodes can be increased in the regions of most interest in the subsurface formation. For example, regions of interest can include faults, horizontal wells, and complex geological structures. The density of nodes in an unstructured grid can be customized for each subsurface formation based on the geology or other characteristics. Lateral and horizontal distribution of “brain” cells and connector should be adjusted on field by field basis. For example, an unstructured grid representing a complex reservoir can include a higher node density than an unstructured grid representing a conventional reservoir.

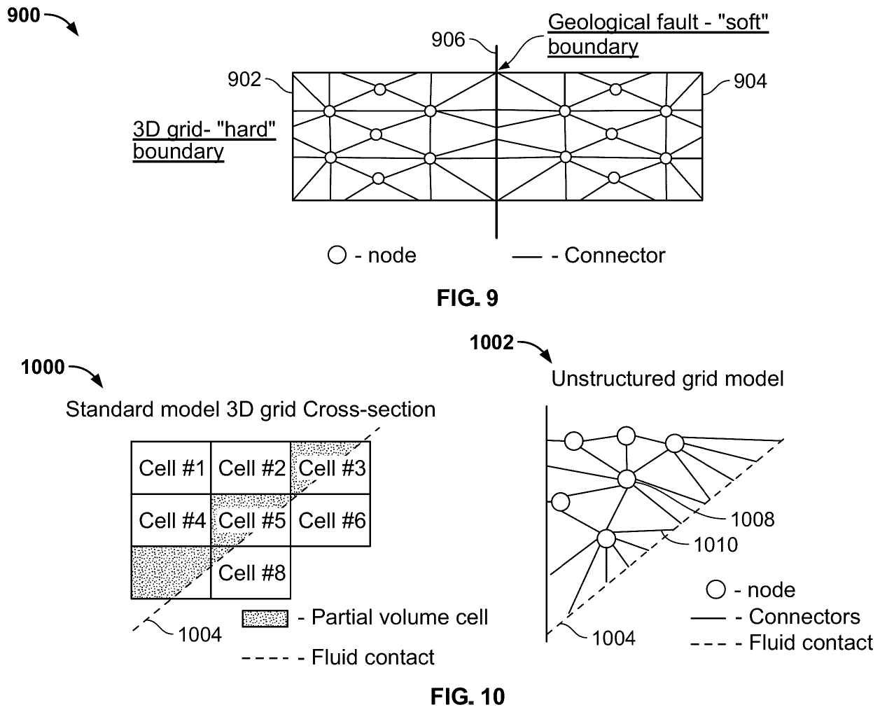

FIG. 9 is a schematic representation of an unstructured grid 900 with hard boundaries 902, 904, and a soft boundary 906. Hard boundaries 902, 904 represent edges of the unstructured grid 900, which can correspond to boundaries of a reservoir in a subsurface formation. Hard boundaries (e.g., hard boundaries 902, 904) are impermeable not allowing fluid communication through the hard boundaries. Soft boundaries (e.g., soft boundary 906) can allow dynamic fluid communication through the boundary. For example, faults, geological layers and fluid contacts can be soft boundaries. Soft boundaries can be partially sealing. For example, a geological fault can be modelled as partially sealing in some cases but in other cases the geological fault can be modelled as sealing at 100%.

FIG. 10 is a schematic comparison of a cubical grid 1000 and an unstructured grid 1002 with a tilted fluid contact 1004. Static fluid volume computation quality can improve for subsurface formations with tilted fluid contacts 1004 (e.g., Free water level (FWL)) using an unstructured grid 1002 with nodes 1008 and connectors 1010 to create the exact intersection with the tilted fluid contact 1004. In case of a tilted FWL, the fluid boundary can be treated as a hard boundary in the grid building process. The spatial density of nodes 1008 can be increased around the boundary. To compute the volume the data processing system can perform a summation of volumes around each node based on its connected connectors 1010. In the case of the cubical grid 1000, modern software packages can compute volumes in a part of a 3D cell (e.g., cells 3, 5, 8); however, the precision of the computation is not as high as computation of full-size cell. The unstructured grid 1002 can provide more accurate volume estimation for fields with tilted fluid contacts, in comparison to cubical grid 1000 model.

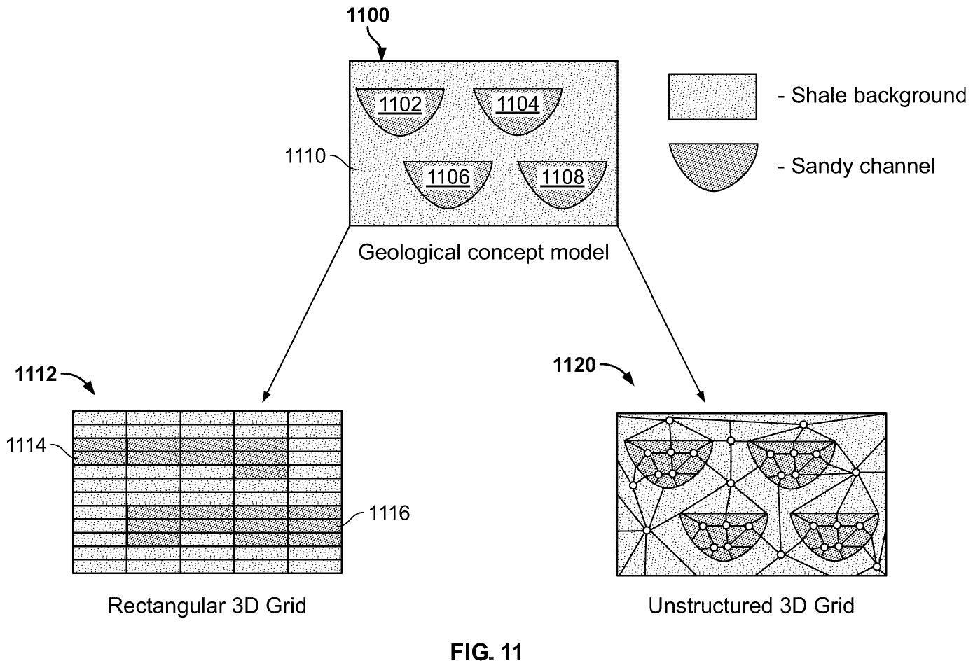

FIG. 11 is a schematic representation of an example geological facies model of a subsurface formation. An initial geological concept model 1100 is generated showing sandy channels 1102, 1104, 1106, 1108 within a shale background 1110. In the case of using a rectangular grid 1112, the sandy channels 1102, 1104, 1106 are upscaled to grid cells. In case of orthogonal cells, the sandy channels will be upscaled to grid cells 1114, 1116 and lose their geological shape. Conversely, using an unstructured grid 1120 can preserve the shape of sandy channels 1102-1108, by using 2 different sets of nodes, a first set of nodes 1122 for the background shale 1110 and a second set of nodes 1124 for the sandy channels 1102-1108. The second set of nodes 1124 has a higher density within the sandy channels 1102-1108. In this manner, the unstructured grid can improve geological facies modelling in 3D space when creating a modeling using, for example, object modeling, Multi point statistics (MPS), or a stochastic indicator simulation (SIS).

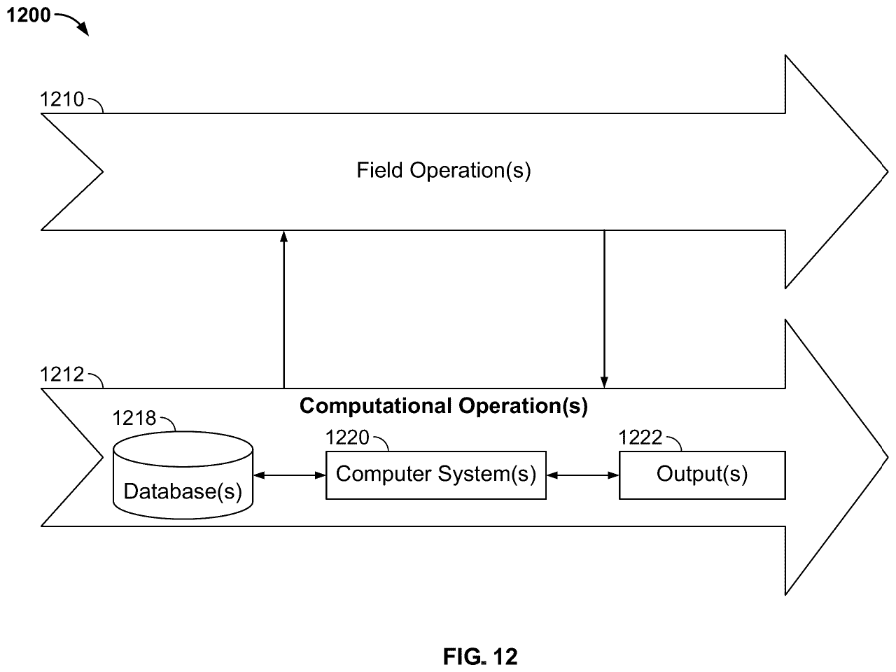

FIG. 12 illustrates hydrocarbon production operations 1200 that include both one or more field operations 1210 and one or more computational operations 1212, which exchange information and control exploration for the production of hydrocarbons. In some implementations, outputs of techniques of the present disclosure (e.g., the method 200) can be performed before, during, or in combination with the hydrocarbon production operations 1200, specifically, for example, either as field operations 1210 or computational operations 1212, or both.

Examples of field operations 1210 include forming/drilling a wellbore, hydraulic fracturing, producing through the wellbore, injecting fluids (such as water) through the wellbore, to name a few. In some implementations, methods of the present disclosure can trigger or control the field operations 1210. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 1210 and responsively triggering the field operations 1210 including, for example, generating plans and signals that provide feedback to and control physical components of the field operations 1210. Alternatively, or in addition, the field operations 1210 can trigger the methods of the present disclosure. For example, implementing physical components (including, for example, hardware, such as sensors) deployed in the field operations 1210 can generate plans and signals that can be provided as input or feedback (or both) to the methods of the present disclosure.

Examples of computational operations 1212 include one or more computer systems 1220 that include one or more processors and computer-readable media (e.g., non-transitory computer-readable media) operatively coupled to the one or more processors to execute computer operations to perform the methods of the present disclosure. The computational operations 1212 can be implemented using one or more databases 1218, which store data received from the field operations 1210 and/or generated internally within the computational operations 1212 (e.g., by implementing the methods of the present disclosure) or both. For example, the one or more computer systems 1220 process inputs from the field operations 1210 to assess conditions in the physical world, the outputs of which are stored in the databases 1218. For example, seismic sensors of the field operations 1210 can be used to perform a seismic survey to map subsurface features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 1212 where they are stored in the databases 1218 and analyzed by the one or more computer systems 1220.

In some implementations, one or more outputs 1222 generated by the one or more computer systems 1220 can be provided as feedback/input to the field operations 1210 (either as direct input or stored in the databases 1218). The field operations 1210 can use the feedback/input to control physical components used to perform the field operations 1210 in the real world.

For example, the computational operations 1212 can process the seismic data to generate three-dimensional (3D) maps of the subsurface formation. The computational operations 1212 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 1212 to process new information about the formation and control the drilling to adjust to the observed conditions in real-time.

The one or more computer systems 1220 can update the 3D maps of the subsurface formation as information from one exploration well is received and the computational operations 1212 can adjust the location of the next exploration well based on the updated 3D maps. Similarly, the data received from production operations can be used by the computational operations 1212 to control components of the production operations. For example, production well and pipeline data can be analyzed to predict slugging in pipelines leading to a refinery and the computational operations 1212 can control machine operated valves upstream of the refinery to reduce the likelihood of plant disruptions that run the risk of taking the plant offline.

In some implementations of the computational operations 1212, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart or are located in different countries or other jurisdictions.

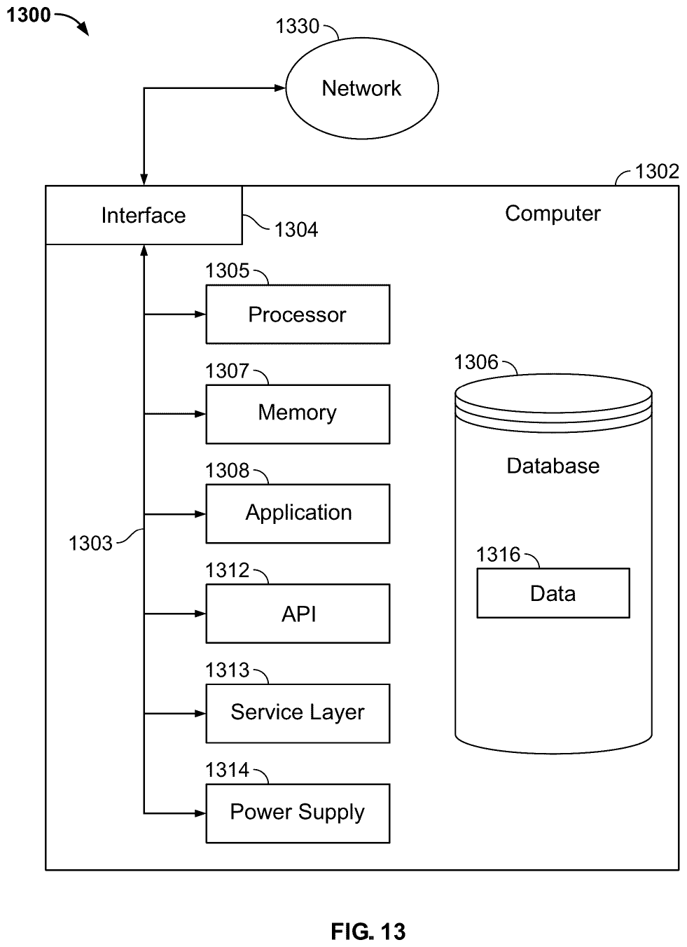

FIG. 13 is a block diagram of an example computer system 1300 used to provide computational functionalities associated with described algorithms, methods, functions, processes, flows, and procedures described in the present disclosure, according to some implementations of the present disclosure. The illustrated computer 1302 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 1302 can include input devices such as keypads, keyboards, and touch screens that can accept user information. Also, the computer 1302 can include output devices that can convey information associated with the operation of the computer 1302. The information can include digital data, visual data, audio information, or a combination of information. The information can be presented in a graphical user interface (UI) (or GUI).

The computer 1302 can serve in a role as a client, a network component, a server, a database, a persistency, or components of a computer system for performing the subject matter described in the present disclosure. The illustrated computer 1302 is communicably coupled with a network 1330. In some implementations, one or more components of the computer 1302 can be configured to operate within different environments, including cloud-computing-based environments, local environments, global environments, and combinations of environments.

At a high level, the computer 1302 is an electronic computing device operable to receive, transmit, process, store, and manage data and information associated with the described subject matter. According to some implementations, the computer 1302 can also include, or be communicably coupled with, an application server, an email server, a web server, a caching server, a streaming data server, or a combination of servers.

The computer 1302 can receive requests over network 1330 from a client application (for example, executing on another computer 1302). The computer 1302 can respond to the received requests by processing the received requests using software applications. Requests can also be sent to the computer 1302 from internal users (for example, from a command console), external (or third) parties, automated applications, entities, individuals, systems, and computers.

Each of the components of the computer 1302 can communicate using a system bus 1303. In some implementations, any or all of the components of the computer 1302, including hardware or software components, can interface with each other or the interface 1304 (or a combination of both), over the system bus 1303. Interfaces can use an application programming interface (API) 1312, a service layer 1313, or a combination of the API 1312 and service layer 1313. The API 1312 can include specifications for routines, data structures, and object classes. The API 1312 can be either computer-language independent or dependent. The API 1312 can refer to a complete interface, a single function, or a set of APIs.

The service layer 1313 can provide software services to the computer 1302 and other components (whether illustrated or not) that are communicably coupled to the computer 1302. The functionality of the computer 1302 can be accessible for all service consumers using this service layer. Software services, such as those provided by the service layer 1313, can provide reusable, defined functionalities through a defined interface. For example, the interface can be software written in JAVA, C++, or a language providing data in extensible markup language (XML) format. While illustrated as an integrated component of the computer 1302, in alternative implementations, the API 1312 or the service layer 1313 can be stand-alone components in relation to other components of the computer 1302 and other components communicably coupled to the computer 1302. Moreover, any or all parts of the API 1312 or the service layer 1313 can be implemented as child or sub-modules of another software module, enterprise application, or hardware module without departing from the scope of the present disclosure.

The computer 1302 includes an interface 1304. Although illustrated as a single interface 1304 in FIG. 13, two or more interfaces 1304 can be used according to particular needs, desires, or particular implementations of the computer 1302 and the described functionality. The interface 1304 can be used by the computer 1302 for communicating with other systems that are connected to the network 1330 (whether illustrated or not) in a distributed environment. Generally, the interface 1304 can include, or be implemented using, logic encoded in software or hardware (or a combination of software and hardware) operable to communicate with the network 1330. More specifically, the interface 1304 can include software supporting one or more communication protocols associated with communications. As such, the network 1330 or the interface's hardware can be operable to communicate physical signals within and outside of the illustrated computer 1302.

The computer 1302 includes a processor 1305. Although illustrated as a single processor 1305 in FIG. 13, two or more processors 1305 can be used according to particular needs, desires, or particular implementations of the computer 1302 and the described functionality. Generally, the processor 1305 can execute instructions and can manipulate data to perform the operations of the computer 1302, including operations using algorithms, methods, functions, processes, flows, and procedures as described in the present disclosure.

The computer 1302 also includes a database 1306 that can hold data for the computer 1302 and other components connected to the network 1330 (whether illustrated or not). For example, database 1306 can hold data 1316. For example, database 1306 can be an in-memory, conventional, or a database storing data consistent with the present disclosure. In some implementations, database 1306 can be a combination of two or more different database types (for example, hybrid in-memory and conventional databases) according to particular needs, desires, or particular implementations of the computer 1302 and the described functionality. Although illustrated as a single database 1306 in FIG. 13, two or more databases (of the same, different, or combination of types) can be used according to particular needs, desires, or particular implementations of the computer 1302 and the described functionality. While database 1306 is illustrated as an internal component of the computer 1302, in alternative implementations, database 1306 can be external to the computer 1302.

The computer 1302 also includes a memory 1307 that can hold data for the computer 1302 or a combination of components connected to the network 1330 (whether illustrated or not). Memory 1307 can store any data consistent with the present disclosure. In some implementations, memory 1307 can be a combination of two or more different types of memory (for example, a combination of semiconductor and magnetic storage) according to particular needs, desires, or particular implementations of the computer 1302 and the described functionality. Although illustrated as a single memory 1307 in FIG. 13, two or more memories 1307 (of the same, different, or combination of types) can be used according to particular needs, desires, or particular implementations of the computer 1302 and the described functionality. While memory 1307 is illustrated as an internal component of the computer 1302, in alternative implementations, memory 1307 can be external to the computer 1302.

The application 1308 can be an algorithmic software engine providing functionality according to particular needs, desires, or particular implementations of the computer 1302 and the described functionality. For example, application 1308 can serve as one or more components, modules, or applications. Further, although illustrated as a single application 1308, the application 1308 can be implemented as multiple applications 1308 on the computer 1302. In addition, although illustrated as internal to the computer 1302, in alternative implementations, the application 1308 can be external to the computer 1302.

The computer 1302 can also include a power supply 1314. The power supply 1314 can include a rechargeable or non-rechargeable battery that can be configured to be either user- or non-user-replaceable. In some implementations, the power supply 1314 can include power-conversion and management circuits, including recharging, standby, and power management functionalities. In some implementations, the power-supply 1314 can include a power plug to allow the computer 1302 to be plugged into a wall socket or a power source to, for example, power the computer 1302 or recharge a rechargeable battery.

There can be any number of computers 1302 associated with, or external to, a computer system containing computer 1302, with each computer 1302 communicating over network 1330. Further, the terms “client,” “user,” and other appropriate terminology can be used interchangeably, as appropriate, without departing from the scope of the present disclosure. Moreover, the present disclosure contemplates that many users can use one computer 1302 and one user can use multiple computers 1302.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, or IOS.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

A number of implementations of these systems and methods have been described. Nevertheless, it will be understood that various modifications may be made without departing from the spirit and scope of this disclosure. Accordingly, other implementations are within the scope of the following claims.

### EXAMPLES

In an example implementations, a method for modeling a subsurface formation includes obtaining geological data and petrophysical data from the subsurface formation; forming an unstructured grid representing the subsurface formation by: determining locations for nodes of the unstructured grid; connecting the nodes to other nodes in the unstructured grid using connectors, where lengths of the connectors are based on distances between the nodes and boundaries of the unstructured grid; assigning geological and petrophysical properties to the nodes based on the geological data and petrophysical data; assigning permeability values to the connectors based on the petrophysical data; and determining a volume of fluids in the subsurface formation based on the lengths of the connectors of the unstructured grid and based on the geological and petrophysical properties assigned to the nodes and the permeability values assigned to the connectors.

An aspect combinable with the example implementation includes controlling hydrocarbon production equipment to produce hydrocarbons from the subsurface formation based on the determined volume of fluids.

Another aspect combinable with any of the previous aspects includes simulating hydrocarbon production from the subsurface formation using the unstructured grid with the geological and petrophysical properties assigned to the nodes and the permeability values assigned to the connectors; and estimating field reserves in the subsurface formation based on the simulated hydrocarbon production.

Another aspect combinable with any of the previous aspects includes generating control commands for hydrocarbon production equipment to produce hydrocarbons from areas in the subsurface formation having a higher hydrocarbon density than other areas in the subsurface formation based on the simulated hydrocarbon production and estimated field reserves.

Another aspect combinable with any of the previous aspects includes determining a density of nodes in the unstructured grid based on stratigraphic layering of the subsurface formation, where the lengths of the connectors are based on the determined density.

In another aspect combinable with any of the previous aspects, the density of nodes in the unstructured grid is higher for regions of the unstructured grid representing faults and horizontal wells in the subsurface formation than for other regions in the unstructured grid.

In another aspect combinable with any of the previous aspects, the unstructured grid is a three-dimensional grid, and each node is connected to twelve connectors.

In another aspect combinable with any of the previous aspects, the unstructured grid comprises hard boundaries representing impermeable limits of the subsurface formation and soft boundaries representing faults, geological layers, and fluid contacts in the subsurface formation, wherein the soft boundaries include a permeability value.

Another aspect combinable with any of the previous aspects includes modeling geological facies of the subsurface formation based on the unstructured grid and the geological data, where a distribution of nodes in the unstructured grid represents geological shapes in the subsurface formation.

In another aspect combinable with any of the previous aspects, assigning geological and petrophysical properties to the nodes is based on a stochastic simulation of a spatial distribution of the geological data and the petrophysical data in the subsurface formation.

Another aspect combinable with any of the previous aspects includes adjusting the lengths of the connectors to conform the boundaries of the unstructured grid to boundaries of the subsurface formation.

In another example implementation, a system for modeling a subsurface formation includes at least one processor and a memory storing instructions that when executed by the at least one processor cause the at least one processor to perform operations including accessing geological data and petrophysical data from the subsurface formation; forming an unstructured grid representing the subsurface formation by determining locations for nodes of the unstructured grid; connecting the nodes to other nodes in the unstructured grid using connectors, wherein lengths of the connectors are based on distances between the nodes and boundaries of the unstructured grid; assigning geological and petrophysical properties to the nodes based on the geological data and petrophysical data; assigning permeability values to the connectors based on the petrophysical data; and determining a volume of fluids in the subsurface formation based on the lengths of the connectors of the unstructured grid and based on the geological and petrophysical properties assigned to the nodes and the permeability values assigned to the connectors.

In an aspect combinable with the example implementation, the operations further include simulating hydrocarbon production from the subsurface formation using the unstructured grid with the geological and petrophysical properties assigned to the nodes and the permeability values assigned to the connectors; and estimating field reserves in the subsurface formation based on the simulated hydrocarbon production.

In another aspect combinable with any of the previous aspects, the operations further include generating control commands for hydrocarbon production equipment to produce hydrocarbons from areas in the subsurface formation having a higher hydrocarbon density than other areas in the subsurface formation based on the simulated hydrocarbon production and estimated field reserves.

In another aspect combinable with any of the previous aspects, the operations further include determining a density of nodes in the unstructured grid based on stratigraphic layering of the subsurface formation, where the lengths of the connectors are based on the determined density.

In another aspect combinable with any of the previous aspects, the operations further include modeling geological facies of the subsurface formation based on the unstructured grid and the geological data, where a distribution of nodes in the unstructured grid represents geological shapes in the subsurface formation.

In another example implementation, one or more non-transitory, machine-readable storage devices storing instructions for modeling a subsurface formation, the instructions being executable by one or more processors, to cause performance of operations including accessing geological data and petrophysical data from the subsurface formation; forming an unstructured grid representing the subsurface formation by: determining locations for nodes of the unstructured grid; connecting the nodes to other nodes in the unstructured grid using connectors, wherein lengths of the connectors are based on distances between the nodes and boundaries of the unstructured grid; assigning geological and petrophysical properties to the nodes based on the geological data and petrophysical data; assigning permeability values to the connectors based on the petrophysical data; and determining a volume of fluids in the subsurface formation based on the lengths of the connectors of the unstructured grid and based on the geological and petrophysical properties assigned to the nodes and the permeability values assigned to the connectors.

In an aspect combinable with the example implementation, the operations further include simulating hydrocarbon production from the subsurface formation using the unstructured grid with the geological and petrophysical properties assigned to the nodes and the permeability values assigned to the connectors; and estimating field reserves in the subsurface formation based on the simulated hydrocarbon production.

In another aspect combinable with any of the previous aspects, the operations further include generating control commands for hydrocarbon production equipment to produce hydrocarbons from areas in the subsurface formation having a higher hydrocarbon density than other areas in the subsurface formation based on the simulated hydrocarbon production and estimated field reserves.

In another aspect combinable with any of the previous aspects, the operations further include determining a density of nodes in the unstructured grid based on stratigraphic layering of the subsurface formation, where the lengths of the connectors are based on the determined density.

What is claimed is:

1. A method for modeling a subsurface formation, the method comprising:
obtaining geological data and petrophysical data from the subsurface formation;
forming an unstructured grid representing the subsurface formation by:
determining locations for nodes of the unstructured grid;
connecting the nodes to other nodes in the unstructured grid using connectors, wherein lengths of the connectors are based on distances between the nodes and boundaries of the unstructured grid;
assigning geological and petrophysical properties to the nodes based on the geological data and petrophysical data;
assigning permeability values to the connectors based on the petrophysical data; and
determining a volume of fluids in the subsurface formation based on the lengths of the connectors of the unstructured grid and based on the geological and petrophysical properties assigned to the nodes and the permeability values assigned to the connectors.

2. The method of claim 1, further comprising:
controlling hydrocarbon production equipment to produce hydrocarbons from the subsurface formation based on the determined volume of fluids.

3. The method of claim 1, further comprising:
simulating hydrocarbon production from the subsurface formation using the unstructured grid with the geological and petrophysical properties assigned to the nodes and the permeability values assigned to the connectors; and
estimating field reserves in the subsurface formation based on the simulated hydrocarbon production.

4. The method of claim 3, further comprising:
generating control commands for hydrocarbon production equipment to produce hydrocarbons from areas in the subsurface formation having a higher hydrocarbon density than other areas in the subsurface formation based on the simulated hydrocarbon production and estimated field reserves.

5. The method of claim 1, further comprising:
determining a density of nodes in the unstructured grid based on stratigraphic layering of the subsurface formation, wherein the lengths of the connectors are based on the determined density.

6. The method of claim 5, wherein the density of nodes in the unstructured grid is higher for regions of the unstructured grid representing faults and horizontal wells in the subsurface formation than for other regions in the unstructured grid.

7. The method of claim 1, wherein the unstructured grid is a three-dimensional grid, and each node is connected to twelve connectors.

8. The method of claim 1, wherein the unstructured grid comprises hard boundaries representing impermeable limits of the subsurface formation and soft boundaries representing faults, geological layers, and fluid contacts in the subsurface formation, wherein the soft boundaries include a permeability value.

9. The method of claim 1, further comprising:
modeling geological facies of the subsurface formation based on the unstructured grid and the geological data,
wherein a distribution of nodes in the unstructured grid represents geological shapes in the subsurface formation.

10. The method of claim 1, wherein assigning geological and petrophysical properties to the nodes is based on a stochastic simulation of a spatial distribution of the geological data and the petrophysical data in the subsurface formation.

11. The method of claim 1, further comprising:
adjusting the lengths of the connectors to conform the boundaries of the unstructured grid to boundaries of the subsurface formation.

12. A system for modeling a subsurface formation, the system comprising:
at least one processor and a memory storing instructions that when executed by the at least one processor cause the at least one processor to perform operations comprising:
accessing geological data and petrophysical data from the subsurface formation;
forming an unstructured grid representing the subsurface formation by:
determining locations for nodes of the unstructured grid;
connecting the nodes to other nodes in the unstructured grid using connectors, wherein lengths of the connectors are based on distances between the nodes and boundaries of the unstructured grid;
assigning geological and petrophysical properties to the nodes based on the geological data and petrophysical data;
assigning permeability values to the connectors based on the petrophysical data; and
determining a volume of fluids in the subsurface formation based on the lengths of the connectors of the unstructured grid and based on the geological and petrophysical properties assigned to the nodes and the permeability values assigned to the connectors.

13. The system of claim 12, wherein the operations further comprise:
simulating hydrocarbon production from the subsurface formation using the unstructured grid with the geological and petrophysical properties assigned to the nodes and the permeability values assigned to the connectors; and
estimating field reserves in the subsurface formation based on the simulated hydrocarbon production.

14. The system of claim 13, wherein the operations further comprise:
generating control commands for hydrocarbon production equipment to produce hydrocarbons from areas in the subsurface formation having a higher hydrocarbon density than other areas in the subsurface formation based on the simulated hydrocarbon production and estimated field reserves.

15. The system of claim 12, wherein the operations further comprise:
determining a density of nodes in the unstructured grid based on stratigraphic layering of the subsurface formation, wherein the lengths of the connectors are based on the determined density.

16. The system of claim 12, wherein the operations further comprise:
modeling geological facies of the subsurface formation based on the unstructured grid and the geological data,
wherein a distribution of nodes in the unstructured grid represents geological shapes in the subsurface formation.

17. One or more non-transitory, machine-readable storage devices storing instructions for modeling a subsurface formation, the instructions being executable by one or more processors, to cause performance of operations comprising:
accessing geological data and petrophysical data from the subsurface formation;
forming an unstructured grid representing the subsurface formation by:
determining locations for nodes of the unstructured grid;
connecting the nodes to other nodes in the unstructured grid using connectors, wherein lengths of the connectors are based on distances between the nodes and boundaries of the unstructured grid;
assigning geological and petrophysical properties to the nodes based on the geological data and petrophysical data;
assigning permeability values to the connectors based on the petrophysical data; and
determining a volume of fluids in the subsurface formation based on the lengths of the connectors of the unstructured grid and based on the geological and petrophysical properties assigned to the nodes and the permeability values assigned to the connectors.

18. The one or more non-transitory, machine-readable storage devices of claim 17, wherein the operations further comprise:
simulating hydrocarbon production from the subsurface formation using the unstructured grid with the geological and petrophysical properties assigned to the nodes and the permeability values assigned to the connectors; and
estimating field reserves in the subsurface formation based on the simulated hydrocarbon production.

19. The one or more non-transitory, machine-readable storage devices of claim 18, wherein the operations further comprise:
generating control commands for hydrocarbon production equipment to produce hydrocarbons from areas in the subsurface formation having a higher hydrocarbon density than other areas in the subsurface formation based on the simulated hydrocarbon production and estimated field reserves.

20. The one or more non-transitory, machine-readable storage devices of claim 17, wherein the operations further comprise:
determining a density of nodes in the unstructured grid based on stratigraphic layering of the subsurface formation, wherein the lengths of the connectors are based on the determined density.
